(19) United States
(12) Patent Application Publication
(10) Pub. No.: US 2008/0215852 A1
(43) Pub. Date: Sep. 4, 2008

(54) System and Device Architecture For Single-Chip Multi-Core Processor Having On-Board Display Aggregator and I/O Device Selector Control

(76) Inventors: Kenneth Largman, San Francisco, CA (US); Anthony B. More, Sebastopol, CA (US); Jeffrey Blair, San Francisco, CA (US); Arthur Abraham, Oakland, CA (US)

Correspondence Address: PERKINS COIE LLP, P.O. BOX 1208, SEATTLE, WA, 98111-1208, US

(21) Appl. No.: 11/848,109

(22) Filed: Aug. 30, 2007

Related U.S. Application Data
(60) Provisional application No. 60/842,087, filed on Aug. 31, 2006.

(51) Int. Cl. G06F 15/76; G06F 9/02

(52) U.S. Cl. 712/28; 712/32; 712/E09.002

(57) ABSTRACT

System, device, device architecture, and method for operating a multi-core processor providing application level file isolation and providing display frame buffer aggregator or selector to provide a user with the experience of multiple simultaneous application execution within a single processor while actually providing separate concurrent but isolated processing sessions.

### CROSS-REFERENCE TO RELATED APPLICATIONS

This application claims the benefit of priority to U.S. Provisional Patent Application Ser. No. 60/842,087 filed 31 Aug. 2006 entitled SYSTEM AND DEVICE ARCHITECTURE FOR SINGLE-CHIP MULTI-CORE PROCESSOR HAVING ON-BOARD DISPLAY AGGREGATOR AND I/O DEVICE SELECTOR CONTROL, which application is hereby incorporated by reference.

### FIELD OF THE INVENTION

This invention pertains to a system, device, device architecture, and method for operating a multi-core processor providing application level file isolation and providing display frame buffer aggregator or selector to provide a user with the experience of multiple simultaneous application execution within a single processor while actually providing separate concurrent but isolated processing sessions.

### BACKGROUND

When based on the prior art, computers, cell phones, and a wide spectrum of devices that use computer or processor technology are vulnerable to computer hackers, viruses, cyber-terrorists, spy-ware, and/or other malicious or harmful computer program code. While anti-virus software is known, such anti-virus software frequently becomes obsolete with each new virus that is written and released. Furthermore, at least some damage will usually be done to some computers during the initial stages of such release. Use of firewalls and other protective measures are also known, however, firewalls are generally not integrated into portable computers or portable computers operating over a public network outside of a corporate Information Technology (IT) environment, and a number of hacking techniques exist to defeat such firewalls in any event. The world-wide cost of damage from computer viruses, spy-ware, and hacking each year has been estimated to run into the tens of billions of dollars. More significantly with the ever increasing reliance on computers to control and maintain operation of air-traffic, transportation systems, building environmental control, stock markets, telephone systems, nuclear-power plants, and other public and private infrastructure, the potential harm from such malicious code goes beyond any monetary assessment.

What is needed is an architecture, system, and operational methodology that provide a measure of immunity from computer hacking, viruses, spy-ware, cyber-terror attacks, and the like, malicious activity.

There is a further need to provide such architecture, system, and operational methodology in a compact package such as on a single integrated circuit, circuit board, or other compact structure.

There is a further need to provide such as compact structure that supports a plurality of processing sessions for a single user and/or a plurality of processing sessions for a plurality of users, where in either situation the processing sessions are isolated from each other so that contamination by computer hacking, viruses, spy-ware, cyber-terror attacks, and the like malicious activity in one process will not contaminate the other processes or a common storage device.

### SUMMARY

In one aspect the invention provides a system, device, device architecture, and method for operating a multi-core processor providing application level file isolation and providing display frame buffer aggregator or selector to provide a user with the experience of multiple simultaneous application execution within a single processor while actually providing separate concurrent but isolated processing sessions.

In one aspect the invention provides a processing device comprising: at least one processor coupled to a random access memory adapted to store data in a storage and instructions during processing, and coupled to a display buffer memory for storing a display data set generated by the processor; a display control circuit adapted to receive at least one display data set from the display buffer memory and for generating an output display data set as a selected one of or as an aggregation or combination of the data set it receives; a file system control circuit for controlling access to an external storage device by the plurality of processors for writing and retrieving data or information to and from the a storage device, the storage device controlling access by at least one of a physical access control and a policy access control; and a input control circuit for arbitrating and controlling an input to a particular one of the plurality of processors selected from among the plurality of processors.

In one aspect the invention provides a method for processing comprising: coupling a plurality of processors to a random access memory system adapted to store data in a storage and instructions during processing and to at least one display buffer memory for storing a display data set generated by the processor; receiving a plurality of display data sets from the plurality of display buffer memories and generating an output display data set as a selected one of or as an aggregation or combination of the plurality of data sets it receives; controlling access to an external storage device by the plurality of processors for writing and retrieving data or information to and from the a storage device, the storage device controlling access by at least one of a physical access control and a policy access control; and arbitrating and controlling an input to a particular one of the plurality of processors selected from among the plurality of processors.

In one aspect the invention provides a multi-core processing system comprising: a plurality of processor cores on a common substrate for executing application programs; a plurality of display frame buffer memories, each coupled to on of the plurality of processor cores; a display frame buffer aggregator or selector controller coupled with the plurality of display frame buffer memories; a file system controller coupled between the plurality of processor cores and an external shared storage device; the file system controller adapted to provide application program level file isolation; and the display frame buffer aggregator or selector adapted to provide a user with the experience of multiple simultaneous application execution within a single processor while actually providing separate concurrent but isolated processing sessions.

### BRIEF DESCRIPTION OF THE DRAWINGS

Embodiments of the invention are illustrated in the figures. However, the embodiments and figures are illustrative rather than limiting; they provide examples of the invention.

FIG. 1 is an illustration showing a single integrated circuit embodiment of the invention.

FIG. 2 is an illustration showing an alternative embodiment of the invention having several microprocessor chips on a common or shared motherboard.

### DETAILED DESCRIPTION OF EMBODIMENTS OF THE INVENTION

In the following description, several specific details are presented to provide a thorough understanding of embodiments of the invention. One skilled in the relevant art will recognize, however, that the invention can be practiced without one or more of the specific details, or in combination with other components, and the like. In other instances, well-known implementations or operations are not shown or described in detail to avoid obscuring aspects of various embodiments, of the invention.

In a first embodiment of the system 101, a single integrated circuit device 102 is utilized and provides an intermittently or temporally isolated multi-core. In the exemplary embodiment, four microprocessors 102-1, 102-2, 102-3, and 102-4 are illustrated though any number N may be provided. It may be further understood that the invention may be implemented with a single general purpose microprocessor 102 in conjunction with the remainder of the control system as described. The use of only a single general purpose microprocessor 102 may limit the number of concurrent or simultaneous processing sessions but would otherwise provide immunity from contamination and an ability to recover files and data in the event of inadvertent execution of viral, hacker, spy-ware or other malicious code.

The system 101 includes as the main components a plurality of general purpose microprocessor (μP) 102-N (where N=1, 2, 3, 4); a display aggregator or display selector 103 that provides means for combining a plurality of video or display data or signals 106-1, . . . , 106-4 from display buffers 107-1, . . . , 107-4; a switch 108 for mouse 110 and keyboard 111 inputs 112, 113, and a file system processor logic or microprocessor 120. A random access memory (RAM) subsystem 130 may be implemented within the single integrated circuit device or on an external integrated circuit so that this RAM may be viewed as being an optional element of the single integrated circuit embodiment. Variations for the RAM configuration are described in greater detail below. Embodiments of the invention may provide for a memory subsystem or RAM 130 having a single RAM device that includes segregated portions or for separate RAM devices 130-1, 130-2, 130-3, and 130-4 coupled with the separate microprocessors 102-1, 102-2, 102-3, 102-4 respectively.

Each of the microprocessors may be running the same operating system 140 or different operating systems. By way of example but not limitation, operating systems made by Microsoft, Apple Computer, Sun Microsystems, Linux, VMware, Xen, or other manufacturers of suppliers may be used, and in some instances may be used in combination with each other. In some embodiments, operating system components may benefit from or require minor modifications so that an appropriate file interface exists and is operable to handle file requests to the file system microprocessor 120.

Advantageously, each microprocessor 102-N has an allocation of and access to a sufficient amount of memory (RAM) 130 as is necessary for its operations, where the memory allocated to each microprocessor 102-N (for example, allocated to microprocessor 102-3) is completely separated from and inaccessible by the other remaining microprocessors (for example, inaccessible by microprocessors 102-1, 102-3, and 102-4). Memory 130-N is allocated to each microprocessor incorporated in the chip dies, provided on one or more units, on a circuit board or by connection thereto, by a combination of these, or by other processes as would be evident to a skilled practitioner of the art so that the memory allocated to any one processor is completely inaccessible to all other processors. The separation and inaccessibility of memory allocated to one microprocessor from another microprocessor is accomplished by separation of communication signals between each processor and the memory assigned to it.

Each general purpose microprocessor 102-N also includes an optional display buffer 125-N into which it can place display information or data from the general purpose microprocessor, whether in symbolic, graphical, image, or other form. The display buffers 107-N are advantageously readable by the display aggregator or selector 103.

In one non-limiting embodiment, a particular one of the plurality of microprocessors, such as for example general purpose microprocessor 102-4, is designated as providing the “desktop” or background display from which files and/or applications are selected for use or processing, such selections being used to start the application in an available different one of the microprocessors. In other words, the particular microprocessor 102-4 is somewhat adapted as its processing task to present a menu or selection display from which a user may select or designate application programs to launch, files to manipulate, read, print or the like, and in at least some instances initiate execution of an application program by virtue of having selected a particular file to access. Selection may be by any means, such as by graphical mouse point and click, by typing in text or symbols, or in any other way.

The display aggregator or selector unit 103 may to some extent be considered to perform either one function and operation or to perform two separate functions or operations. These may be considered as one combined function or operation, or as two separate functions of operations depending upon the embodiment. When considered as a display aggregator component 103A alone, the display aggregator unit 103A combines the information, data, or signals from the plurality of different display buffers 107-N so that the information, data, or signals can be displayed or presented to a user on a single display device 160. It will be appreciated that embodiments of the invention support the use of multiple display devices and that the purpose here is to provide function and means for combining or aggregating the display for processing that is occurring in separate microprocessors, which in at least one embodiment are operating in isolations from each other, into a single display. When considered as a display selector 103B, the display selector unit 103B selects one of the display buffers 125-N where the selection is controlled by a selector switch or other display buffer selection logic. In all cases the resulting display text, graphic, image, or the like is sent to an appropriate display device 160.

Switch 108 is controlled by the switch control unit 109 which receives a mouse signal 112 and a keyboard signal 113 from the mouse 110 and keyboard 111 respectively to monitor the mouse or other pointing device movements or commands and any keyboard or keypad inputs to determine which of the microprocessors has been selected by the user for an input, and sets the switch 145 so that the mouse and keyboard inputs 146, 147 are received by the selected general purpose microprocessor 102-N. The determination of which of the general purpose microprocessors has been selected may be made directly or based on a determination of the region or window of the display the pointer or cursor is overlying and a mapping of that display screen location or coordinate to the microprocessor and process that is associated with that location or coordinate.

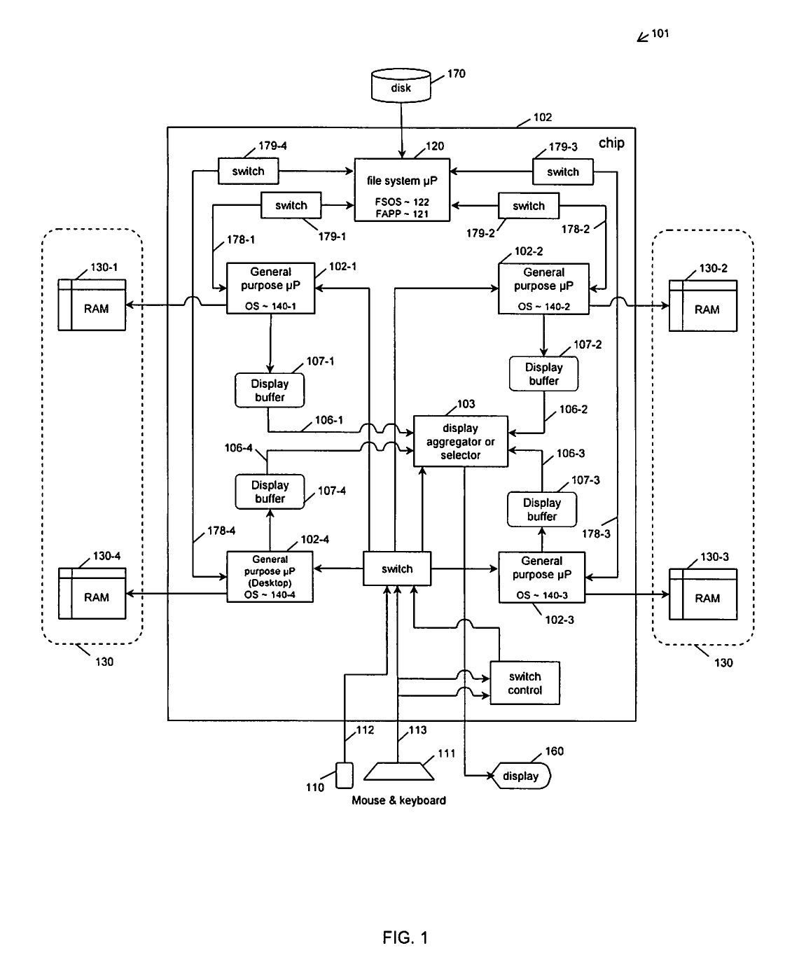

It may be appreciated that although a single display 160, mouse, and keyboard are illustrated in the embodiment of FIG. 1, that multiple displays, mice, and/or keyboards (or other input/output) devices may be provided with associated changes in the input I/O switch 108 logic and display aggregator and selector logic 103.

Attention is now directed to the file system processor or microprocessor 120, only one of which is provided for in the system 101. Each microprocessor 102-N is also advantageously coupled with or connected to the file system processor logic or microprocessor 120 via a communications path 178-N through a switch 179-N. File system processor logic or microprocessor 120 runs an file system operating system (FSOS) 122 configured to manage the file system and is interposed between the general purpose microprocessors 102-N and a mass storage device such as for example but not limited to a hard disk drive, optical disk, solid state memory or the like 170. The file system processor or microprocessor unit 120 is designed and implemented to enforce appropriate file access and protection policies (FAPP) 121. Access between each general purpose microprocessor 102-N and the file system microprocessor 120 may also optionally be controlled via a separate (optional) file system access switch 179-N so that in at least some embodiments, access may be both physically based and policy based.

By way of example but not limitation, the file access and protection policies 121 may include rules or policies that: (i) prevent any executable files to be modified, (ii) to allow only one microprocessor at a time to access a single file, (iii) to limit the number of files a particular microprocessor can access, (iv) to allow only certain groups of files to be accessed at one time, (v) an combination of these, and/or (iv) any other rule or policy that may provide the desired file access and protection. Means may be provided for a trusted administrator to override certain rules or policies so that files may be updated or modified from time to time as may be required for system or machine maintenance.

With further reference to FIG. 1, the random access memory (RAM) unit 130 or units 130-N may be provided within the single integrated circuit or chip 102 of the system 101 or on a separate integrated circuit. RAM 130 (or separate RAM 130-1, 130-2, 130-3, 130-4) may also be coupled to the single integrated circuit by means of a plug in socket or connector on a board carrying the single integrated circuit (or carrying multiple integrated circuits as described relative to other embodiments of the invention below). When provided on the same integrated circuit the integration is complete, and when provided on a separate integrated circuit further isolation is provided.

Conventionally, a microprocessor retrieving a file from a storage device and returning the processed file back to the storage device after processing may be permitted to read (an write) a file directly and continuously from the file storage device. This type of operation may lead to the contamination of the contents in the microprocessor, RAM, and/or other files or data on the storage device since potentially executable code (including unknown or undetected virus, hacker code, spyware, or other malicious code) is exposed to a means for executing the code (e.g., the processor and memory) as well as means for storing the results of such execution (e.g., the storage device, the memory, and possibly even the processor) so that contamination of other files or data may occur from any one of these sources at a later time.

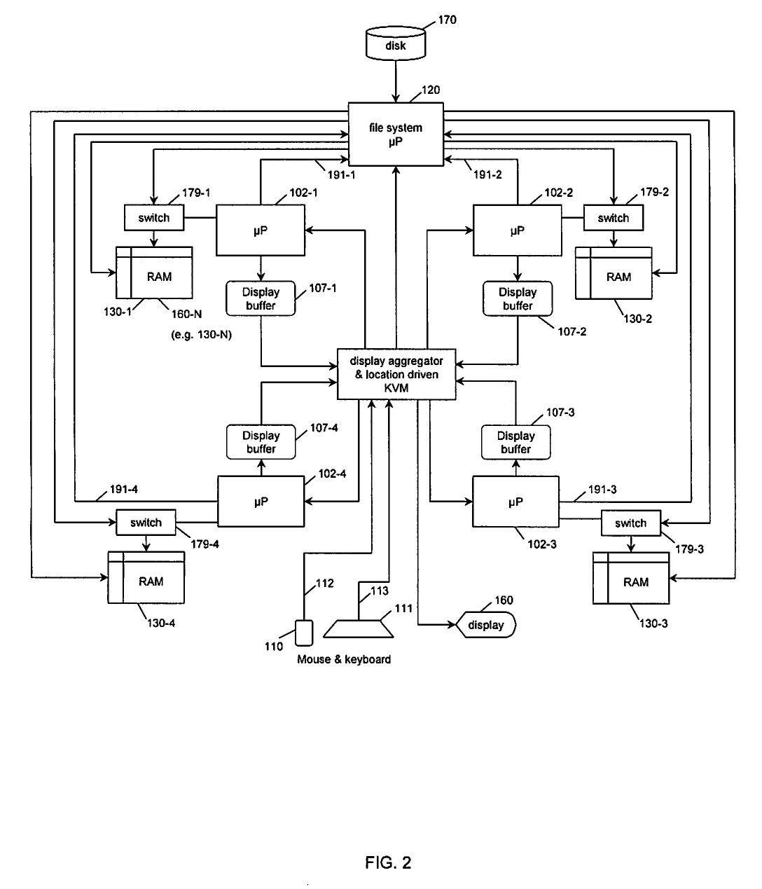

With reference to FIG. 2, in one embodiment, rather than allowing any of the general purpose microprocessors 102-N to read a file or data directly or continuously from the file system processor 120 to the secondary file storage location 160-N, the file for which access by the microprocessor is desired is transferred completely to a secondary storage device 161 attached to a respective one of the general purpose microprocessors and then the copied file is read from this secondary file storage location. In one embodiment, the general purpose microprocessor secondary file storage location 160-N may be the RAM 130-N associated with that microprocessor 102-N, or it may be a separate RAM or other secondary storage. After the file is transferred from the storage 170 via the file system processor 120 to the secondary file storage location 160-N, connections between the general purpose microprocessor's secondary file storage location 160-N and the file system processor 120 (as well as with storage 170) are severed by use of a controlled switch or switching logic 179-N. Advantageously, the copy operation may be performed by copy means that will not permit execution of any known or unknown executable code segments that might be in the copied files or data, such as for example viral code, hacker code, spyware code, or other malicious code.

In this embodiment the general purpose microprocessors 102-N retain signaling lines 191-N connected to a file control or supervisory system 123, which in one embodiment is the file system microprocessor 120, to indicate such conditions as for example: (i) completion of processing, (ii) request for a file, (iii) user requesting a “copy/paste” type operation between microprocessors, and/or (iv) other such conditions or operations as one skilled in the art could devise or desire to implement.

As an example of how the file control or supervisory system 123 may respond to such a signal or signals from the general purpose microprocessors 102-N, attention is directed to an example for a “completion of processing” type signal. Assuming that an input file was processed so that the processed output file is an updated or modified version of the original input file, the required operation is to transfer the updated file which now contains the results of the processing back to the file storage. This transfer operation back to the file storage is accomplished by activating a controlled switch 179-N to connect the microprocessor secondary storage to the primary file storage, such as file storage hard disk drive 160 or other mass storage device and performing the file transfer. Again the file transfer may optionally but advantageously be accomplished by a copy operation and by copy means that will not permit execution of any known or unknown executable code segments that might be in the copied files or data.

In an alternative embodiment or in an enhancement to other of the embodiments, the control or supervisory system 120 may halt the operation of the microprocessor while the transfer of a file to the secondary storage is in progress to achieve even further isolation between the microprocessor system and the file storage system. In this way, transfer of the file from the file storage system to the microprocessor's secondary storage occurs while the microprocessor is deactivated or disconnected from its own secondary storage. In this way the file cannot be corrupted by the microprocessor while it is being transferred, and there is no possibility of communication between the microprocessor and the file storage system. After the transfer is complete the file storage system first disconnects itself from the file storage system and then reconnects or re-activates the microprocessor.

Yet still another embodiment provides further protection for the file storage system is obtained by separating it into two parts a readable part and writable part, each part being a physically different storage system. A first storage system part functions as described above by allowing files to be both read from and written to. The second storage system part is configured to allow only reading, where the reading only is accomplished by access or read means that renders writing physically impossible. This may involve a physical or hardware modification that is not susceptible to being surreptitiously altered such as by some malicious code, a virus, or by hacker code or intervention.

In one embodiment, the second storage system part renders read-only operation and prevents writing by interrupting the write-enable signal line with a switch. In another embodiment, the second storage system part renders read-only operation and prevents writing by using a storage device such as a hard disk drive or other storage device that is constructed without a write head, or some functionally equivalent means as can be devised by one skilled in the art. For example a solid state memory device such as a compact flash card, memory stick, or other storage with a write protect switch or feature may be used. Files desired to be write-only are written to the storage device before the write function is disabled. This might be at the time of manufacture or assembly, or at set-up of the device for its final use as through a switch operated by the user or the control system. Using a switch operated by the control system would allow for eventual updating of the read-only portion of the storage device by the control system, but this might not be desirable for certain usages. In one embodiment the switch of control logic would only be accessible to trusted user or trusted administrator. In another embodiment, physical access to the computing device may be required to alter the switch or control logic for write access.

In still another alternative embodiment, the storage system includes two parts, however, the two parts of the file storage system are not physically separate but reside on or within the same device being kept completely isolated from each other by segregation of addressing lines.

In one non-limiting embodiment, this addressing line based segregation may be accomplished by setting the high-order bit to zero (“0”) on the collection of addressing lines representing the read-only part of the storage device, and by setting the high-order bit to one (“1”) on the collection of addressing lines representing the write enabled portion through the use of an AND gate or similar or other logic circuit or device such that both the write-enable and addressing line must both be in the “1” state to allow writing to be enabled. It will be appreciated that different logic schemes may be selected, such as by reversing the roles of logic “1” and logic “0”. The high-order line being also connected to the write-enable line thus making the writing of the read-only part of the storage system impossible though means or methods known in the art.

Several alternative means for providing or maintaining separation or isolation have been described. In generally each may be used to provide the desired separation or isolation, and to the extent that they do not conflict or can be modified so as not to conflict may be used in combination. It will also be appreciated in light of the description provided here that other means may be implemented for effectively separating the memory on a single carrier or substrate into several or a plurality of subsections which are irrevocably or provisionally separate to reduce the number of separate memory units either for purposes of reducing the area requirements of such memory units, for reducing the costs of the memory units or total memory, or for other reasons.

As described with respect to embodiments of the invention above, it may be appreciated that in certain environments, hardware-based separation of operation and function may be preferred as it reduces or eliminates the likelihood that virus, hacker, spyware, or malicious code may gain access to control and therefore defeat the file isolation and protection means and mechanisms. However, it should also be appreciated that other embodiments of the invention may provide for some or all of the separation of operation and function described herein to be accomplished by means of software programming rather than the physical means already described. Other embodiments may also provide for hybrid hardware and software (or firmware) means and mechanisms for providing the file isolation and protection described.

In yet another embodiment, separate microprocessors may be utilized instead of microprocessors integrated into a single chip, integrated, circuit, or substrate. Alternatively, an embodiment in which a plurality of multi-microprocessor integrated circuits are provided onto a printed circuit board may be utilized. In either of these alternative embodiments, a plurality of separate single microprocessor or a plurality of multiple processor microprocessor chips or multi-core microprocessor integrated circuits are assembled onto a single circuit board (or boards in mother-daughter relationship) along with the remainder of the main components as described above. The functioning of the components is as described above though the packaging and placement may differ. One skilled in the art can quickly recognize the existence of possible embodiments representing a continuum of modifications between implementations where all components exist as separate units attached to a single circuit board and single integrated circuit implementations having all components accomplished within the compass of a single integrated circuit.

An embodiment of this invention may also be practiced as a multiple board assemblage by assembling a number of single board computers in place of the microprocessors shown above, an industry standard KVM switcher device (Keyboard/Video/Mouse) slightly modified to respond to control functions, a common single board controller to supply system coordination, and one or more standard video overlay devices to supply the function of the display aggregator or selector device.

As used herein, the term “embodiment” means an embodiment that serves to illustrate by way of example but not limitation. It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

1. A processing device comprising:
at least one processor coupled to a random access memory adapted to store data in a storage and instructions during processing, and coupled to a display buffer memory for storing a display data set generated by said processor;
a display control circuit adapted to receive at least one display data set from said display buffer memory and for generating an output display data set as a selected one of or as an aggregation or combination of the data set it receives;
a file system control circuit for controlling access to an external storage device by the plurality of processors for writing and retrieving data or information to and from the a storage device, the storage device controlling access by at least one of a physical access control and a policy access control; and
a input control circuit for arbitrating and controlling an input to a particular one of the plurality of processors selected from among the plurality of processors.

2. A processing device as in claim 1, wherein said at least one processor comprises a plurality of processors including a first processor and a second processor, each said processor coupled to a random access memory adapted to store data and instructions during processing in that particular processor and coupled to a display buffer memory for storing a display data set generated by that particular processor; and
said a display control circuit adapted to receive a plurality of display data sets from a plurality of display buffer memories coupled to said plurality of processors and for generating an output display data set as a selected one of or as an aggregation of combination of the plurality of data sets it receives.

3. A processing device as in claim 2, further comprising at least one random access memory circuit coupled with said plurality of processors.

4. A processing device as in claim 2, wherein said plurality of processors, said display control circuit, said file system control circuit, and said input control circuit are fabricated in a single integrated circuit.

5. A processing device as in claim 2, wherein said plurality of processors, said display control circuit, said file system control circuit, said input control circuit, and said at least one random access memory are fabricated in a single integrated circuit.

6. A processing device as in claim 2, wherein the storage device comprises a persistent storage device.

7. (canceled)

8. A processing device as in claim 2, wherein said display control circuit comprises means for combining a plurality of video or display data signals from a plurality of display buffers associated with a like plurality of general purpose processors and for generating a single output display data set as a selected one of or as an aggregation or combination of the plurality of data sets it receives.

9. A processing device as in claim 2, wherein said file system control circuit for controlling access to an external storage device by the plurality of processors further comprises:
a file system processing logic circuit coupled with a storage device on which the files are stored; and
at least one switching logic coupled to the file system processing logic circuit and to the at least one processor.

10-11. (canceled)

18. A processing device as in claim 16, wherein the switch control logic communicates with the plurality of processors to determine which of said processors should receive the input based on either a command included with the input or a location of a pointing device.

19. (canceled)

20. A processing device as in claim 2, wherein a transfer of a file from the file storage system storage device to a processor storage occurs while the microprocessor is deactivated or disconnected from a processor secondary storage so that the file being transferred cannot be corrupted by the processor while it is being transferred, and there is no possibility of communication between the processor and the file system storage device.

21. A processing device as in claim 1, wherein said at least one processor comprises a plurality of processors including a first processor and a second processor, each said processor coupled to a random access memory adapted to store data and instructions during processing in that particular processor and coupled to a display buffer memory for storing a display data set generated by that particular processor; and said display control circuit adapted to receive a plurality of display data sets from a plurality of display buffer memories coupled to said plurality of processors and for generating an output display data set as a selected one of or as an aggregation of combination of the plurality of data sets it receives;
further comprising: at least one random access memory circuit coupled with said plurality of processors;
said plurality of processors, said display control circuit, said file system control circuit, and said input control circuit are fabricated in a single integrated circuit;
said plurality of processors, said display control circuit, said file system control circuit, said input control circuit, and said at least one random access memory are fabricated in a single integrated circuit;
said storage device comprises a persistent storage device;
said at least one processor comprises a microprocessor or central processing unit;
said display control circuit comprises means for combining a plurality of video or display data signals from a plurality of display buffers associated with a like plurality of general purpose processors and for generating a single output display data set as a selected one of or as an aggregation or combination of the plurality of data sets it receives;
said file system control circuit for controlling access to an external storage device by the plurality of processors further comprises: a file system processing logic circuit coupled with a storage device on which the files are stored; and at least one switching logic coupled to the file system processing logic circuit and to the at least one processor; said file system processing logic circuit comprises a file system microprocessor;
said at least one switching logic coupled to the file system processing logic circuit and to the at least one processor comprises at least one switch;
said at least one processing logic comprises a plurality of processing logic circuits; and
said at least one switching logic coupled to the file system processing logic circuit and to the at least one processor comprises a plurality of switching logic circuits, each of the plurality of switching circuits interposed between one of the plurality of processing logic circuits and said file system processing logic control circuit for enabling or disabling a communication between the processing logic circuit and the file system processing logic control circuit;
said plurality of switching logic circuits comprise a plurality of switches;
said display control circuit comprises a display aggregator unit that combines the information, data, or signals from the plurality of different display buffers so that the information, data, or signals are displayed to a user on a single display device;
said display control circuit comprises a display selector unit that selects one of the display buffers where the selection is controlled by a selector switch or other display buffer selection logic;
said input control circuit for arbitrating and controlling an input to a particular one of the plurality of processors selected from among the plurality of processors comprises an input switching logic and a switch control logic, said input switching logic and said switch control logic receiving said input, said switch control logic controlling a state of said input switching logic to determine which particular one of said plurality of processor should receive the input and directing the input to that particular processor;
said switch control logic communicates with the plurality of processors to determine which of said processors should receive the input based on either a command included with the input or a location of a pointing device;
said input comprises at least one of a mouse input, a keyboard input, a pointing device input, a touch screen input, or any combination of two or more of these inputs; and
a transfer of a file from the file storage system storage device to a processor storage occurs while the microprocessor is deactivated or disconnected from a processor secondary storage so that the file being transferred cannot be corrupted by the processor while it is being transferred, and there is no possibility of communication between the processor and the file system storage device.

22. A method for processing comprising:
coupling a plurality of processors to a random access memory system adapted to store data in a storage and instructions during processing and to at least one display buffer memory for storing a display data set generated by said processor;
receiving a plurality of display data sets from said plurality of display buffer memories and generating an output display data set as a selected one of or as an aggregation or combination of the plurality of data sets it receives;
controlling access to an external storage device by the plurality of processors for writing and retrieving data or information to and from the a storage device, the storage device controlling access by at least one of a physical access control and a policy access control; and
arbitrating and controlling an input to a particular one of the plurality of processors selected from among the plurality of processors.

23. A method as in claim 22, the step of generating an output display data set further comprises: aggregating the display data set into a single display.

24. A method as in claim 22, the step of generating an output display data set further comprises: selecting a plurality of display devices and selectively displaying the output display data set to the plurality of display devices.

25-33. (canceled)

34. A computing device comprising:
at least one processor having a plurality of processing cores disposed on a single substrate and adapted for generating a plurality of computing environments;
a plurality of display frame buffer memories, each coupled to one of said plurality of processor cores;
a display frame buffer aggregator or selector controller coupled with said plurality of display frame buffer memories;
a file system controller coupled between said plurality of processor cores and an external shared storage device;
the file system controller adapted to provide application program level file isolation; and
the display frame buffer aggregator or selector adapted to provide a user with the experience of multiple simultaneous application execution within a single processor while actually providing separate concurrent but isolated processing sessions.

35. A method for operating a computer having a shared display device and a shared input/output user interface, the method comprising:
controlling a file system adapted to provide application program level file isolation in at least one processor comprising a plurality of processor cores;
executing a plurality of different application programs concurrently within different cores of said plurality of processor cores, the concurrent execution requiring substantially independent inputs to the different processor cores and generating substantially independent outputs from the different processor cores;
operating an input/output device selector controller coupled with the processor to control the inputs to and outputs from the different processor cores; and
operating a display selector or aggregator receiving an input from each of said plurality of processor cores to provide a user with the experience of multiple simultaneous application execution within a single processor while actually providing separate concurrent but isolated processing sessions.
